(19) United States
(12) Patent Application Publication
(10) Pub. No.: US 2024/0169200 A1
(43) Pub. Date: May 23, 2024

(54) PROFILING-BASED JOB ORDERING FOR DISTRIBUTED DEEP LEARNING

(71) Applicant: KOREA UNIVERSITY RESEARCH AND BUSINESS FOUNDATION, Seoul (KR)

(72) Inventors: Changyong SHIN, Seoul (KR); Gyeongsik YANG, Seoul (KR); Yeonho YOO, Seoul (KR); Jeunghwan LEE, Seoul (KR); Hyuck YOO, Seoul (KR)

(73) Assignee: KOREA UNIVERSITY RESEARCH AND BUSINESS FOUNDATION, Seoul (KR)

(21) Appl. No.: 18/329,720

(22) Filed: Jun. 6, 2023

(30) Foreign Application Priority Data
Nov. 17, 2022 (KR) 10-2022-0154609

(51) Int. Cl. G06N 3/08

(52) U.S. Cl. CPC G06N 3/08

(57) ABSTRACT

Disclosed is a profiling-based distributed deep learning job ordering method and apparatus. The ordering method refers to a distributed deep learning job ordering method performed by a computing device including at least a processor and includes profiling each of a plurality of distributed deep learning jobs; and selecting distributed deep learning jobs to concurrently run based on profiling results.

### CROSS-REFERENCE TO RELATED APPLICATION(S)

This application claims the benefit under 35 USC § 119(a) of Korean Patent Application No. 10-2022-0154609 filed on Nov. 17, 2022 in the Korean Intellectual Property Office, the entire disclosure of which is incorporated herein by reference for all purposes.

### BACKGROUND

### 1. Field

At least one example embodiment relates to a deep learning job ordering method for improving a distributed deep learning job completion speed in a graphics processing unit (GPU) cloud, and more particularly, to a method and apparatus for selecting distributed deep learning jobs most suitable to concurrently run based on profiling results for active/idle durations of GPU and GPU memory utilization for distributed deep learning jobs.

### 2. Description of Related Art

In the case of recent deep learning models, the number of layers and the number of parameters of a model are increasing to improve accuracy and a size of training data being input is also increasing. Therefore, an astronomical amount of time is used to train a deep learning model using only a single graphics processing unit (GPU) and training may be impossible on a single GPU due to lack of GPU memory. Therefore, a plurality of GPUs may be used to accelerate a training speed of the deep learning model or enables training of the deep learning model that is infeasible with a single GPU.

Distributed deep learning (DDL) training is divided into a method of distributing training data and a method of distributing deep learning models. In the case of distributing training data, a process of synchronizing training results is required since the same deep learning model is trained on a plurality of GPUs. A synchronization method includes a parameter server (PS) method that centrally collects training results and then distributes the updated parameters to each GPU and an all-reduce method that allows the respective GPUs to share the training results.

In general, a cloud refers to a computing form that operates large-scale computing resources, provides a service of automating the use of computing resources, and lends computing resources requested by a user if necessary. Computing resources provided from the cloud are divided into Software as a Service (SaaS), Infrastructure as a Service (IaaS), Platform as a Service (PaaS), and the like according to a form of a corresponding computing resource.

Currently, as expensive GPU resources are essentially used for training a deep learning model, cloud-based model training has become very active. Cloud computing companies directly provide GPU resources in a form of IaaS or provide Machine Learning as a Service (MLaaS) that is a service of providing a tool optimized for machine learning including deep learning.

### SUMMARY

A technical subject of at least one example embodiment is to address that graphics processing unit (GPU) utilization patterns and job completion time (JCT) of distributed deep learning (DDL) jobs are very diverse and, to solve this, to select jobs most suitable to concurrently run by profiling DDL jobs, to adjust order in which the jobs are executed, that is, run, and through this, to reduce an amount of time in which all jobs are completed, that is, JCT.

Studies are suggested that GPU utilization is very low in the existing GPU cloud and, to solve this, studies that concurrently run two or more jobs on a single GPU are suggested. Although a deep learning model training job is running, GPU utilization may be improved by additionally running a deep learning model training job to a GPU with low GPU utilization.

However, GPU usage characteristics of concurrently running jobs are still not considered. Since a job completion time (JCT) greatly varies depending on concurrently running distributed deep learning jobs, job characteristics need to be considered. Also, out-of-memory (OoM) errors are not solved in a GPU cloud. To maximize GPU utilization, at least two deep learning jobs are running on a single GPU. However, if a sum of GPU memory that requires concurrent running jobs exceeds GPU memory capacity, an OoM error occurs and training is suspended.

A profiling-based distributed deep learning job ordering method according to an example embodiment refers to a distributed deep learning job ordering method performed by a computing device including at least a processor and includes profiling each of a plurality of distributed deep learning jobs; and selecting distributed deep learning jobs to concurrently run based on profiling results.

Also, the profiling may include extracting an active duration, an idle duration, and a GPU memory utilization of each of the plurality of distributed deep learning jobs.

Also, the selecting may include selecting one distributed deep learning job from among the plurality of distributed deep learning jobs; and selecting another distributed deep learning job to concurrently run with the one distributed deep learning job from among the plurality of distributed deep learning jobs based on the active duration, the idle duration, and the GPU memory utilization.

Also, the selecting of the one distributed deep learning job may include selecting a first distributed deep learning job in a run queue as the one distributed deep learning job.

Also, the selecting of the other distributed deep learning job may include filtering out distributed deep learning jobs that require a memory greater than a value acquired by subtracting a maximum GPU memory utilization of the one distributed deep learning job from GPU memory capacity, among the plurality of distributed deep learning jobs.

Also, the selecting of the other distributed deep learning job may include selecting, from among the filtered distributed deep learning jobs, a distributed deep learning job having an active-idle ratio closest to the inverse of an active-idle ratio of the one distributed deep learning job as the other distributed deep learning job.

Also, the active-idle ratio may be a ratio between the active duration and the idle duration.

According to a distributed deep learning job ordering method and apparatus according to an example embodiment, it is possible to profile GPU usage characteristics and required memory of concurrently running jobs and to select distributed deep learning jobs suitable to concurrently run, to adjust job order, and to thereby reduce a sum of JCT of the entire jobs.

Therefore, the present invention refers to a technique that may improve a training speed of distributed deep learning in profiling and GPU cloud job placement operations at a level of a deep learning library and thus, is effectively used on a GPU cloud in which distributed deep learning is mainly performed.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a graph showing graphics processing unit (GPU) utilization of a VGG 16 model trained with ImageNet training data for 5 seconds;

FIG. 2 is a graph showing profiling results of GPU utilization patterns for distributed deep learning jobs;

FIG. 3 is a graph showing a normalized job completion time (JCT) for each of distributed deep learning job sets;

FIG. 4 illustrates a method of measuring an active duration and an idle duration of GPU at a level of a deep learning library;

FIG. 5 is a graph showing JCT located at 75%, 90%, and 99% on the average and distribution of results of 50 experiments;

FIG. 6 is a diagram illustrating a distributed deep learning job ordering apparatus according to an example embodiment; and

FIG. 7 is a flowchart illustrating a distributed deep learning job ordering method according to an example embodiment.

### DETAILED DESCRIPTION

The aforementioned features and effects of the disclosure will be apparent from the following detailed description related to the accompanying drawings and accordingly those skilled in the art to which the disclosure pertains may easily implement the technical spirit of the disclosure.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component.

For example, a first component may be referred to as a second component, or similarly, the second component may be referred to as the first component within the scope of the present disclosure. As used herein, the term “and/or” includes any and all combinations of one or more of the associated listed items.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Hereinafter, example embodiments will be described with reference to the accompanying drawings. However, the scope of the patent application is not limited to or restricted by the example embodiments. Like reference numerals used in the respective drawings refer to like elements throughout.

A deep learning library refers to a framework that enables convenient development of a deep learning model by providing an abstracted application programming interface (API) capable of using various deep learning algorithms. The present invention analyzes an internal execution structure for profiling of distributed deep learning jobs based on TensorFlow that is a representative deep learning library. However, the present invention is not limited thereto. The execution structure of the deep learning library is as follows.

Codes written with high-level API are converted into various detailed operations including a matrix multiplication. The converted detailed operations are expressed as a computation graph that includes operation order and dependence information. The detailed operations expressed as nodes of the computation graph are sequentially executed along the graph and performed as operations implemented on a device to actually run.

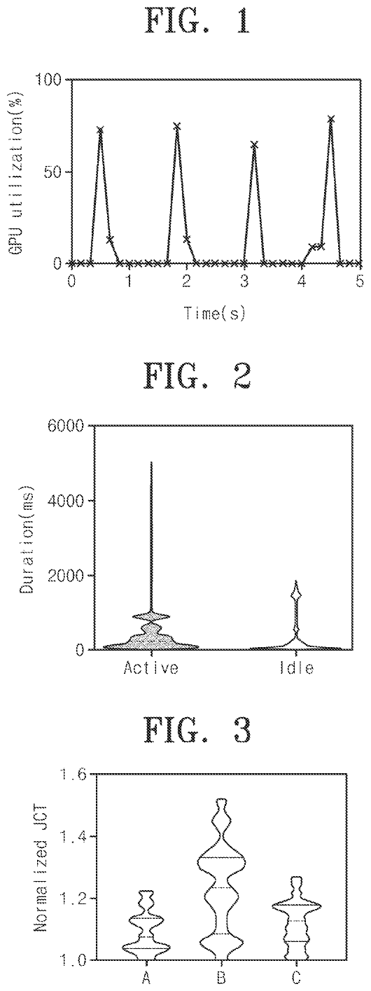

Distributed deep learning that is aimed by the present invention is a data distribution method and requires a process of synchronizing training results of each GPU every training period and active and idle durations of GPU resources iteratively appear due to a synchronization process. FIG. 1 is a graph showing graphics processing unit (GPU) utilization of a VGG 16 model trained with ImageNet training data for 5 seconds. Referring to FIG. 1, active and idle durations repeat a total of four times and similar GPU utilization patterns appear in most training jobs of a deep learning model.

The present invention profiled GPU utilization patterns for 600 cases of distributed deep learning jobs using benchmarking tool provided from TensorFlow that is a distributed deep learning library and results are illustrated in FIG. 2. Referring to FIG. 2, the active duration ranges from 5 ms to 1.8 s and the idle duration ranges from 5 ms to 4.9 s, showing a difference of up to 1000 times. Since GPU utilization and idle durations show diversity, profiling GPU utilization patterns of deep learning jobs is required.

The present invention aims to enhance a job completion time (JCT) of a distributed deep learning job. The job completion time (JCT) refers to an amount of time used from a time at which a distributed deep learning job is requested to a GPU cloud to a time at which the distributed deep learning job is completed and corresponding results are returned to a user having requested the corresponding job.

Experiments were conducted to show a change in JCT according to job execution order of distributed deep learning jobs. A total of three job sets A, B, and C are generated by randomly selecting 10 jobs from among 600 distributed deep learning jobs. The experiments were concurrently performed on a single GPU by randomly selecting two jobs from each job set and executed jobs were excluded from a corresponding job set. When one job out of two jobs is completed, a job may be randomly selected from among jobs that remain in a job set and may be concurrently executed. The JCT was measured by repeating the above process until there is no remaining job in a corresponding job set. The measured JCT is also referred to as a normalized JCT acquired by normalizing normalized values based on a maximum JCT value. The normalized JCT is illustrated in FIG. 3. Here, as a result of repeating 25 experiments on each job set, the normalized JCT shows high variability from 1.2 times (job set A) to 1.5 times (job set B). Also, it can be seen that the distributed deep learning job running order has great effect on variability in terms of a training speed of distributed deep learning, that is, efficacy.

The present invention relates to a method and apparatus (or system) for ordering concurrently running jobs for distributed deep learning job acceleration and largely includes two techniques. The two techniques include 1) a distributed deep learning job profiling method and 2) an ideal concurrently running distributed deep learning job selection method. Description related thereto is sequentially made.

For profiling of distributed deep learning, active and idle durations of GPU need to be measured when a job is executed on the GPU. GPU utilization may be measured using the existing techniques, such as Nvidia management library (NVML) that is a GPU profiling tool. However, active and idle durations of GPU may not be measured.

To measure GPU active and idle durations of distributed deep learning jobs, execution structure analysis contents of TensorFlow v1.6 may be used. A deep learning library code internally records execution start time and end time of each detailed operation by identifying a device in which a corresponding detailed operation is executed. The GPU active duration is defined as a duration of time from a start time of a first detailed operation to an end time of a last detailed operation among consecutively executed detailed operations and the GPU idle duration is defined as a duration of time from the end time of the last detailed operation to a start time of a first detailed operation among subsequent continuously executed detailed operations. Distributed deep learning jobs most suitable to concurrently run may be selected using profiling results.

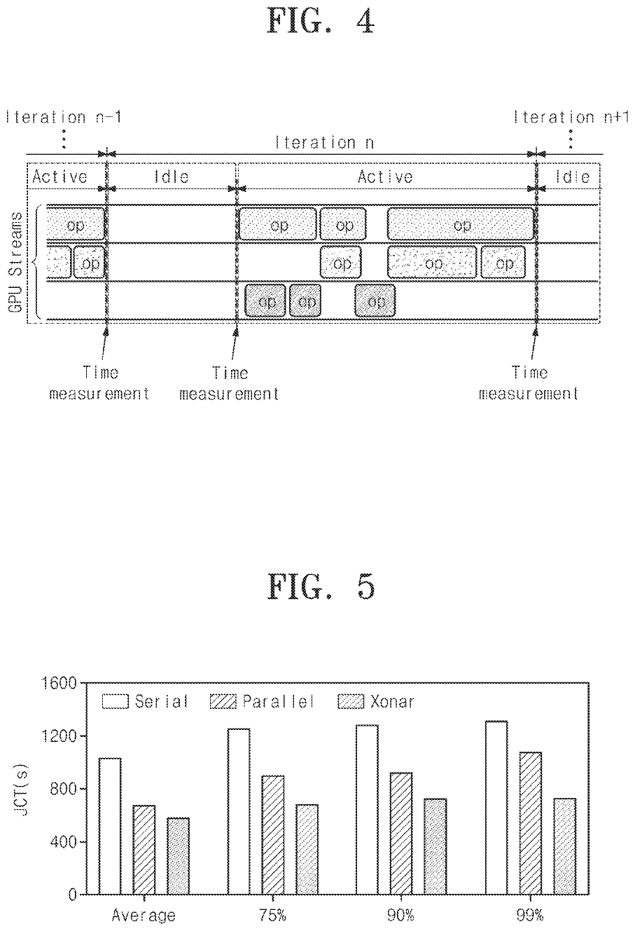

FIG. 4 illustrates a method of measuring an active duration and an idle duration of GPU at a level of a deep learning library. As an example, an internal acting method may be verified by analyzing a TensorFlow deep learning library at a code level to measure GPU active and idle durations and active and idle durations may be measured by measuring a start time and an end time of op that is a detailed operation unit converted from a TensorFlow code. In FIG. 4, op represents a detailed operation unit converted from a TensorFlow code. According to an example embodiment, a log code may be added to a TensorFlow code and an active duration and an idle duration may be measured through log parsing.

To measure GPU memory utilization of a distributed deep learning job, maximum GPU utilization of a job is measured. A memory utilization pattern of a distributed deep learning job shows a periodic pattern similar to a GPU utilization pattern and an NVML tool may be used to measure the maximum utilization. Using analysis results, an Out-of-Memory (OoM) error that may occur in the process of running distributed deep learning jobs may be prevented. The OoM error occurs when a memory required for a job running in GPU is greater than capacity of GPU memory. When the OoM error occurs, all jobs running in the GPU are suspended and need to be restarted from the beginning.

For example, to measure GPU memory utilization, the memory utilization may be measured by calling an NVML API provided from NVIDIA that is a GPU manufacturer at predetermined intervals (e.g., at intervals of ⅙ seconds). Here, a distributed deep learning job suitable to concurrently run may be selected based on highest GPU memory utilization among a plurality of iterations.

63.4 seconds (s) on average was used for analyzing (profiling) each distributed deep learning job. In general, since distributed deep learning jobs running on a GPU cloud generally use hundreds of minutes on average, a profiling time may be overlapped with a waiting time of a job in a run queue and is not recognized as great overhead.

Job completion time (JCT) of distributed deep learning jobs greatly varies according to job running order and GPU active and idle durations of distributed deep learning jobs variously appear. If an idle duration of a concurrently running job is short, the other job may have less opportunity to utilize the GPU. On the contrary, if the idle duration is long, the other job may have more opportunity to utilize the GPU. Therefore, it is possible to more efficiently reduce the JCT by adjusting the running order of deep learning jobs in consideration of profiling results.

Initially, a first job (J_A), that is, a distributed deep learning job to first run is selected from a run queue and fitness is scored in terms of two factors to find another distributed deep learning job (J_P) to concurrently run with J_A. A first factor is GPU memory utilization. To avoid an OoM error, a distributed deep learning job that requires a memory greater than a current available GPU memory (i.e., a value acquired by subtracting maximum GPU memory utilization of J_A from GPU memory capacity) is filtered out. For the filtered jobs (Q_filtered), a second factor, that is, fitness between active and idle durations between jobs is considered. For each job of Q_filtered (J_n), an active-idle ratio (r_n) is calculated by dividing the active duration of J_n by its idle duration. For example, with the assumption that r_A (active-idle ratio of J_A) is 6/4, proper J_P may be a job of which r_P is the inverse of r_A (i.e., 4/6) since the active duration of J_P may overlap the idle duration of J_A. Therefore, J_P most suitable to concurrently run with J_A may be selected using the following Equation 1.

$${J}_{P} = {min}_{{J}_{n} ∈ {Q}_{filtered}} \vert {r}_{A} \times {r}_{n} - 1 \vert \qquad [ Equation 1 ]$$

Referring to Equation 1, a job having an active-idle ratio that makes the product with the active-idle ratio of the first job (J_A) closest to 1 may be selected as a job to concurrently run. That is, a job having an active-idle ratio having a smallest difference with the active-idle ratio of the first job (J_A) may be selected as the job to concurrently run.

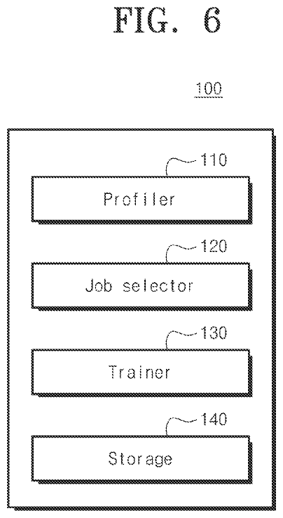

For performance evaluation, 10 jobs randomly selected from among 600 cases of distributed deep learning jobs were executed with three execution methods, that is, running methods and the experiment was repeated 50 times by changing the randomly selected jobs. The three execution methods include a method of running only one job at the same time (Serial), a method of randomly selecting and running two jobs at the same time (Parallel), and a method of concurrently selecting and running two jobs according to a profiling-based concurrently running job selection method (Xonar). FIG. 5 illustrates JCT located at 75%, 90%, and 99% on average and distribution of results of 50 experiments. For the average JCT, Xonar reduces the JCT by up to 43.6% and 13.7% compared to Serial and Parallel, respectively. Improvements are greater for JCT results located at the tail on the distribution. Xonar bounds the JCT of 99% within 736 seconds, while Serial and Parallel reach up to the JCT of 1,317 seconds and 1,083 seconds, respectively. This represents that 99% tail JCT of Xonar is 44.1% and 32% lower than those of Serial and Parallel. The experiment results show that the present invention significantly reduces JCT of distributed deep learning jobs and may successfully prevent an OoM error since the OoM error does not occur.

FIG. 6 is a diagram illustrating a distributed deep learning job ordering apparatus according to an example embodiment.

Referring to FIG. 6, a distributed deep learning job ordering apparatus 100 may also be referred to as a distributed deep learning apparatus, a job ordering apparatus, and an ordering apparatus, and may be implemented as a computing device that includes at least a processor and/or memory. The computing device may include a personal computer (PC), a server, and the like, and may be implemented as a single physical device or may be implemented as a plurality of physical devices.

The ordering apparatus 100 includes a profiler 110 and a job selector 120. Depending on example embodiments, the ordering apparatus 100 may further include a trainer 130 and/or a storage 140.

The profiler 110 may profile each of a plurality of distributed deep learning jobs. At least two distributed deep learning jobs among the plurality of distributed deep learning jobs may be concurrently trained using a plurality of GPUs. That is, the present invention premises a distributed deep learning environment. As a result of profiling, information on an active duration, an idle duration, and GPU memory utilization about each of the plurality of distributed deep learning jobs may be acquired. The active duration and the idle duration may represent an active duration and an idle duration for a single iteration, or may represent an average active duration for a plurality of iterations or an average idle duration for the plurality of iterations. Also, the GPU memory utilization may represent a maximum value of GPU memory utilization generated during training the plurality of iterations, that is, maximum GPU memory utilization.

The job selector 120 may select a distributed deep learning job to currently run. In detail, when one distributed deep learning job is running, the job selector 120 may select another distributed deep learning job to perform training concurrently with the one distributed deep learning job from among the plurality of distributed deep learning jobs.

In detail, the job selector 120 may select one (e.g., a first distributed deep learning job among distributed deep learning jobs in a run queue) from among the plurality of distributed deep learning jobs and then may select another distributed deep learning job to concurrently run with the selected distributed deep learning job. To this end, the job selector 120 may select one distributed deep learning job that satisfies a GPU memory utilization condition and an active and idle duration condition from among the plurality of distributed deep learning jobs.

The trainer 130 may train at least two distributed deep learning jobs. The concurrently running at least two distributed deep learning jobs may represent the one distributed deep learning job and the other distributed deep learning job selected by the job selector 120. Depending on example embodiments, the one distributed deep learning job may represent the first distributed deep learning job in the run queue and the other distributed deep learning job may represent the distributed deep learning job to concurrently run with the one distributed deep learning job, selected by the job selector 120. Depending on example embodiments, the concurrently running at least two distributed deep learning jobs may run on a single GPU. Therefore, the ordering apparatus 100 may be understood to include the GPU for concurrently running at least two distributed deep learning jobs.

The storage 140 may store an operating system (OS), an application, an app, and a program related thereto, necessary for operating the ordering apparatus 100. Also, the storage 140 may store the plurality of distributed deep learning jobs (, which may be understood as the concept that includes a model to be trained, such as a neural network model, and training data) to be trained, profiling results by the profiler 110, results of selection by the job selector 120 and data transitorily or non-transitorily generated in a selection process, and training results (e.g., a trained model) by the trainer 130.

Each of components of the ordering apparatus 100 illustrated in FIG. 6 may be functionally and logically separated and one of ordinary skill in the art may easily infer that each component is not classified as a separate physical device or written with a separate code.

Also, “part”, “module”, and “unit” used herein may represent a functional and structural combination of hardware for performing the technical spirit of the present invention and software for driving the hardware. For example, the module may represent a predetermined code and a logical unit of a hardware resource for performing the predetermined code and does not necessarily represent a physically connected code or one type of hardware.

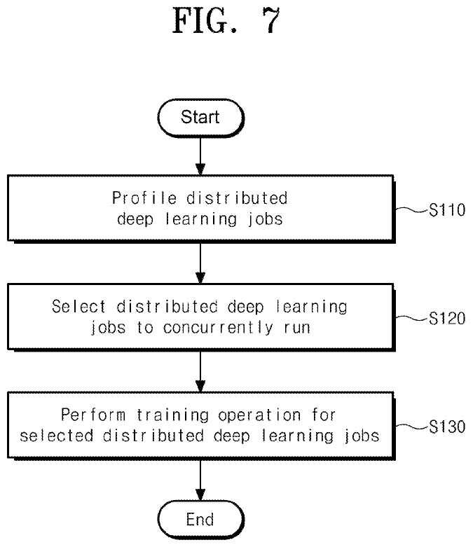

FIG. 7 is a flowchart illustrating a distributed deep learning job ordering method according to an example embodiment. A job ordering method also referred to as an ordering method may be performed by a computing device (or an ordering apparatus) described above with reference to FIG. 6. Depending on example embodiments, at least a portion of operations included in the ordering method may be understood to be performed by a processor of the computing device. Hereinafter, description that overlaps the aforementioned description is omitted.

Initially, in operation S110, a plurality of distributed deep learning jobs may be profiled. Through profiling, information on an active duration, an idle duration, and GPU memory utilization for each of the plurality of distributed deep learning jobs may be extracted.

In operation S120, at least two distributed deep learning jobs to concurrently run may be selected. The at least two distributed deep learning jobs include one distributed deep learning job (e.g., a first distributed deep learning job in a run queue) selected by an arbitrary method and another distributed deep learning job to concurrently run with the one distributed deep learning job. The other distributed deep learning job needs to satisfy a GPU memory utilization condition and an active/idle duration condition.

In operation S130, a training operation for the selected at least two distributed deep learning jobs may be performed. As a result of a concurrent operation, trained models corresponding to the at least two distributed deep learning jobs, respectively, may be generated.

The aforementioned method according to example embodiments may be implemented in a form of a program executable by a computer apparatus. Here, the program may include, alone or in combination, a program instruction, a data file, and a data structure. The program may be specially designed to implement the aforementioned method or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method are described, the apparatus and method are not limited to the aforementioned example embodiments. Various apparatuses or methods implementable in such a manner that one of ordinary skill in the art makes modifications and alterations based on the aforementioned example embodiments may be an example of the aforementioned apparatus and method. For example, although the aforementioned techniques are performed in order different from that of the described methods and/or components such as the described system, architecture, device, or circuit may be connected or combined to be different form the above-described methods, or may be replaced or supplemented by other components or their equivalents, it still may be an example embodiment of the apparatus and method.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. A distributed deep learning job ordering method performed by a computing device comprising at least a processor, the method comprising:
profiling each of a plurality of distributed deep learning jobs; and
selecting distributed deep learning jobs to concurrently run based on profiling results.

2. The method of claim 1, wherein the profiling comprises extracting an active duration, an idle duration, and a graphics processing unit (GPU) memory utilization of each of the plurality of distributed deep learning jobs.

3. The method of claim 2, wherein the selecting comprises:
selecting one distributed deep learning job from among the plurality of distributed deep learning jobs; and
selecting another distributed deep learning job to concurrently run with the one distributed deep learning job from among the plurality of distributed deep learning jobs based on the active duration, the idle duration, and the GPU memory utilization.

4. The method of claim 3, wherein the selecting of the one distributed deep learning job comprises selecting a first distributed deep learning job in a run queue as the one distributed deep learning job.

5. The method of claim 3, wherein the selecting of the other distributed deep learning job comprises filtering out distributed deep learning jobs that require a memory greater than a value acquired by subtracting a maximum GPU memory utilization of the one distributed deep learning job from GPU memory capacity, among the plurality of distributed deep learning jobs.

6. The method of claim 5, wherein the selecting of the other distributed deep learning job comprises selecting, from among the filtered distributed deep learning jobs, a distributed deep learning job having an active-idle ratio closest to the inverse of an active-idle ratio of the one distributed deep learning job as the other distributed deep learning job.

7. The method of claim 6, wherein the active-idle ratio is a ratio between the active duration and the idle duration.
